(19) United States
(12) Patent Application Publication
(10) Pub. No.: US 2009/0227912 A1
(43) Pub. Date: Sep. 10, 2009

(54) Chair-type Massaging Machine

(76) Inventors: Kouichi Enami, Hyogo (JP); MyongSik Kim, Osaka (JP)

Correspondence Address: BIRCH STEWART KOLASCH & BIRCH, PO BOX 747, FALLS CHURCH, VA, 22040-0747, US

(21) Appl. No.: 11/658,895

(22) PCT Filed: Dec. 12, 2005
(86) PCT No.: PCT/JP2005/022783

§ 371 Date: Jan. 30, 2007

(30) Foreign Application Priority Data
Jun. 17, 2005 (JP) 2005-178093

(51) Int. Cl. A61H 1/00

(52) U.S. Cl. 601/49

(57) ABSTRACT

A chair-type massaging machine includes: a seat surface 3a for a massagee h to be seated thereon; a plantar-arch projection 5t for the seated massagee h to place plantar arches h6 thereon; and a heel-massaging air cell 53 capable of clamping and pressing heels h3 in a feet-resting position where the plantar arches h6 rest on the plantar-arch projection 5t, and effectively massages the heels and soles.

### TECHNICAL FIELD

The present invention relates to a chair-type massaging machine.

### BACKGROUND ART

Some of the chair-type massaging machines are adapted to massage heels and soles. Japanese Laid Open Patent Application Publication No. 2004-215938 (hereinafter, referred to as “Prior-Art Document”), for example, discloses a chair-type massaging machine which includes: a sole support surface for supporting massagee's soles rested thereon, and a heel support surface upstanding from a rear side of the sole support surface for supporting heels on the rear sides thereof, wherein the heel support surface is provided with a heel massaging portion for clamping and pressing a rear part of each heel, and wherein the sole support surface is provided with a sole massaging portion for pressing each sole.

### DISCLOSURE OF THE INVENTION

A heel of human body is configured to be progressively decreased in width toward the rear end thereof. Therefore, a pressing force of the heel massaging portion clamping and pressing the heel is directed toward a toe side as inclined relative to a longitudinal direction of the sole, so that a component force toward the toe is produced.

This may lead to the following problem. The heel is pushed out by the heel massaging portion clamping the heel, so as to be displaced from the heel massaging portion. Hence, the heel massaging portion may be unable to apply an effective pressure to the heel. Furthermore, when the heel is pushed out as described above so that the sole is moved toward the toe, a pressure point on the sole is displaced so that a massage effect on the sole is also decreased.

In view of the foregoing, the invention has an object to provide a chair-type massaging machine capable of applying effective massage to the heel and sole.

The invention has contrived the following technical features to achieve the above object.

Specifically, the chair-type massaging machine according to the invention comprises: a seat surface for a massagee to be seated thereon; a plantar-arch projection for the seated massagee to place plantar arches thereon; and a heel massaging portion capable of clamping and pressing heels in a feet-resting position where the plantar arches rest on the plantar-arch projection.

In this case, the machine is adapted to massage the heel as allowing the plantar arch of the foot to be pressed against a projected portion of the plantar-arch projection. By virtue of a physical locking effect of the plantar-arch projection, the sole is less prone to be displaced (moved) toward the toe when the heel is clamped and pressed. In addition, the plantar-arch projection has an acupressure effect on the plantar arch. As a result, the heel and plantar arch may be effectively massaged.

It is preferred that a space extending sole-normally downwardly of the plantar-arch projection is provided at an area around the plantar-arch projection and on a heel-location side with respect to the feet-resting position. In this case, the degree of freedom of setting contact angle or abutting positions of the soles relative to the plantar-arch projection is increased because the massagee is allowed to insert the massagee's heels into the above space by varying the angles of ankles. Accordingly, the plantar-arch projection may provide an even higher massage effect on the soles.

It is further preferred that the space defined around the plantar-arch projection and on the heel-location side with respect to the feet-resting position is open downward in the sole-normal direction. In this case, the aforesaid space on the heel-location side is provided. What is more, the above space prevents the soles from getting sweaty or prevents dirt and dust separated from the soles from being accumulated in the neighborhood of the plantar-arch projection. Thus are ensured quite comfortable conditions for sole massage.

It is further preferred that a space capable of receiving the heels is provided at place sole-longitudinally rearwardly of the heel location with respect to the feet-resting position. In this case, the massagee is allowed to shift sole-longitudinal positions of the soles by inserting the heels into the above space. This results in an increased degree of freedom of setting the sole-longitudinal positions of the soles. Hence, the massagee can press any desired parts of the soles against the plantar-arch projection. In addition, the degree of freedom of selecting the position of massage applied by the heel massaging portion is also increased.

It is further preferred that the plantar-arch projection is exposed for directly contacting the plantar arches of the massagee's feet.

In this case, the plantar-arch projection is prevented from being flattened due to a cover member and the like covering the plantar-arch projection. Therefore, the physical locking effect of the plantar-arch projection is enhanced even further, so that a more effective massage may be applied to the plantar arches and the heels.

### BRIEF DESCRIPTION OF THE DRAWINGS

FIG. 1 is a perspective view showing a chair-type massaging machine according to one embodiment of the invention;

FIG. 2 is a side view of the chair-type massaging machine of FIG. 1;

FIG. 3 is a diagram of a second segment of a footrest as viewed from above along a sole-normal direction;

FIG. 4 is a diagram of the second segment of the footrest as viewed from front along a sole-longitudinal direction;

FIG. 5 is a diagram illustrating how the feet of a massagee are massaged by the second segment;

FIG. 6 is a side view of the chair-type massaging machine for disclosing a reclining mechanism and a footrest angle interlocking mechanism, the view showing a state where a backrest is raised to the uppermost position;

FIG. 7 is a side view of the chair-type massaging machine for disclosing the reclining mechanism and the footrest angle interlocking mechanism, the view showing a state where the backrest is inclined to a lower position than that of FIG. 6; and

FIG. 8 is a group of diagrams showing abutment relation between a plantar-arch projection 5t and a foot.

### DESCRIPTION OF REFERENCE CHARACTERS

1: Chair-type massaging machine
3: Seat
3a: Seat surface
5: Footrest
53: Heel massaging air cell (heel massaging portion)
5t: plantar-arch projection
U: Sole-longitudinal direction
H: Sole-normal direction
k1: First space (space defined sole-longitudinally rearwardly of heel location with respect to feet-resting position)
(k2: Second space (space defined at an area around the plantar-arch projection and on a heel-location side with respect to the feet-resting position and extending sole-normally downwardly of the plantar-arch projection)
h: Massagee
h1: Sole
h3: Heel
h6: Plantar arch

### BEST MODE FOR CARRYING OUT THE INVENTION

A preferred embodiment of the invention will hereinbelow be described with reference to the accompanying drawings.

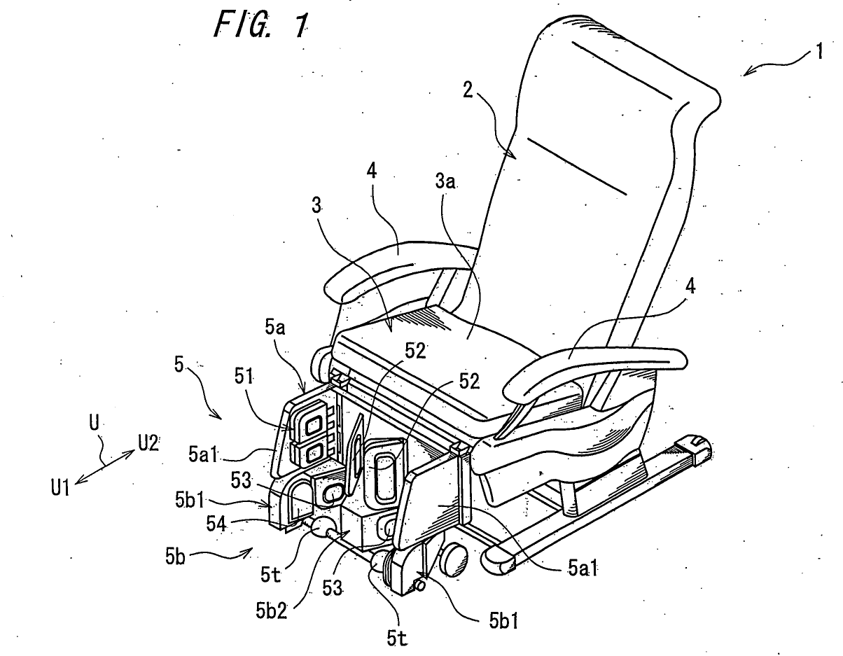

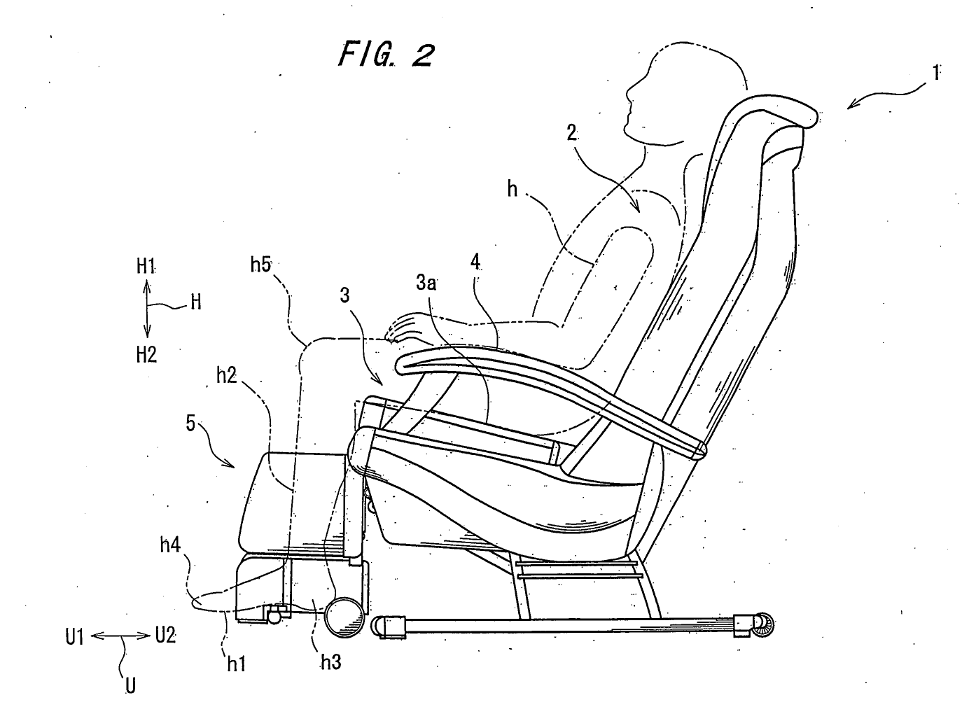

FIG. 1 is a perspective view showing the whole body of a chair-type massaging machine 1 according to one embodiment of the invention, whereas FIG. 2 is a side view thereof. As shown in these figures, the chair-type massaging machine 1 includes: a backrest 2 capable of supporting a seated massagee h on the back and the head; a seat 3, an upper surface of which defines a seat surface 3a capable of supporting the hips and thighs of the massagee h; an armrest 4 disposed on lateral sides of the machine for supporting the arms of the massagee h; a footrest 5 for the massagee h to place the calves and soles therein. FIG. 1 shows the footrest 5 removed of a cover in order to disclose an internal mechanism of the footrest 5.

Although not shown in the figures, massaging members, such as an air cell, massaging element and vibrator, for applying massage to the massagee h are disposed at suitable places in the backrest 2 and the seat 3. A lower part of the seat 3 accommodates an unillustrated air supply mechanism for supplying air to these air cells and air cells of the footrest 5 to be described hereinlater, an unillustrated controller for controlling the operations of the individual massaging members, and the like. As shown in FIG. 1, a plurality of air cells for massaging the calves, heels, soles and the like (the details of which will be described hereinlater) are disposed at the footrest 5.

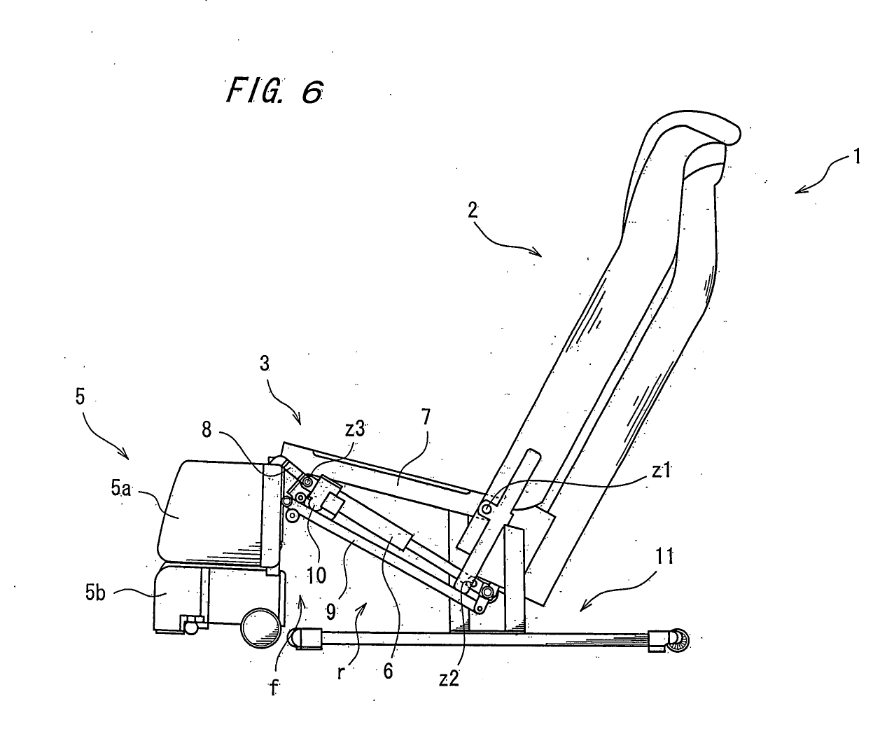

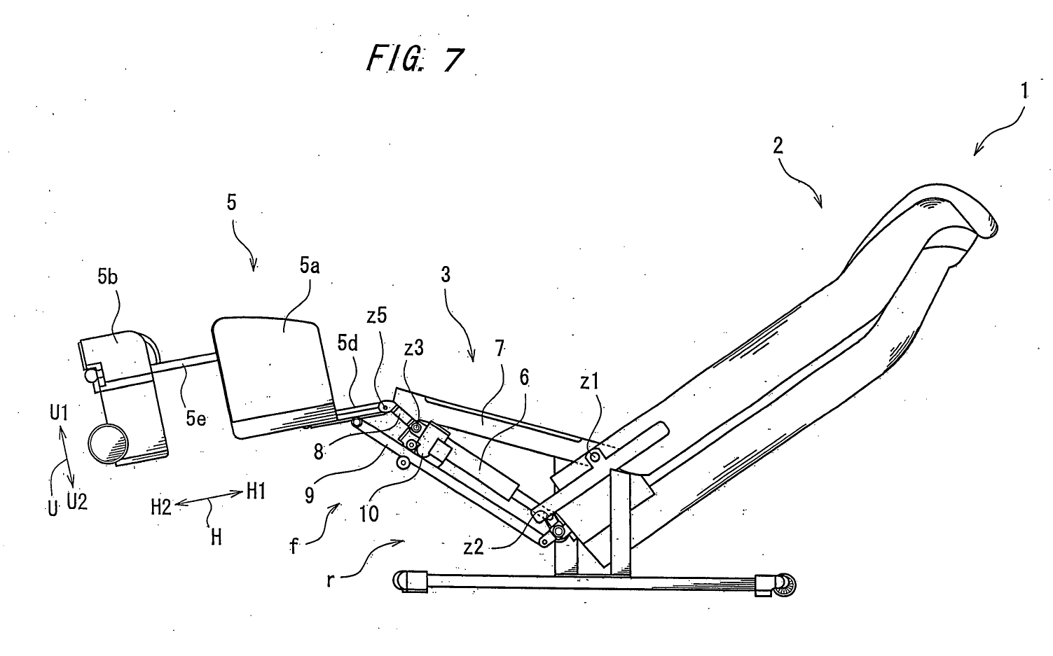

The chair-type massaging machine 1 includes a reclining mechanism r adapted to vary the angle of inclination of the backrest 2. FIG. 6 and FIG. 7 are side views showing an internal mechanism of the reclining mechanism r. As shown in these figures, the reclining mechanism r includes: a frame member 7 disposed in the seat 3 and extended in a depth-wise direction of the seat 3; a first pivot shaft z1 for pivotally interconnecting one end of the frame member 7 (end adjacent to the backrest 2) and a lower part of the backrest 2; a second pivot (shaft z2 disposed at a bottom portion of the backrest 2; and a third pivot shaft z3 disposed at the other end of the frame member 7 (end adjacent to the footrest 5). The second pivot shaft z2 is disposed closer to a lower end of the backrest than the first pivot shaft z1 with respect to a longitudinal direction of the backrest. The second pivot shaft z2 is disposed at the lower end of the backrest 2. The first pivot shaft z1 is disposed at the lower part of the backrest 2 and at place near the seat surface of the seat 3. An expandable/contractable actuator 6 has one thereof pivotally connected to a bottom portion of the backrest 2 by means of the second pivot shaft z2, and has the other end thereof pivotally connected to the other end of the frame member 7 by means of the third pivot shaft z3. According to the reclining mechanism r of such a structure, as the actuator is expanded longer, the backrest 2 is inclined lower. As the actuator 6 is contracted shorter, the backrest 2 is raised higher. FIG. 6 shows a state where the backrest 2 is raised to the uppermost position. FIG. 7 shows a state where the backrest 2 is inclined at a predetermined angle.

While the frame member 7 of the seat 3 is disposed on lateral sides of the seat 3, FIG. 6 and FIG. 7 omits the depiction of a front-side one of the lateral frame members 7 in the interest of easy view of the internal mechanism of the reclining mechanism r.

The chair-type massaging machine 1 further includes a footrest angle interlocking mechanism f which is operatively associated with the above inclination of the backrest 2 for varying the angle of the footrest 5 relative to the seat 3 (or an installation surface of the chair). As shown in FIG. 6 and FIG. 7, the footrest angle interlocking mechanism f includes: a pivot shaft z4 disposed at the bottom portion of the backrest 2; a link member 9 which has one end thereof connected to the bottom portion of the backrest 2 by means of the pivot shaft z4 and has the other end thereof abutted against the footrest 5 (a backside portion 5c thereof); and a pair of rollers 15 for clamping the link member 9 as slidably moved between the one end and the other end thereof. The rollers 15 are fixed to a transverse frame member 8 which interconnects the respective other ends of the lateral frame members 7 as extended in the transverse direction thereof. The rollers 15 permit the sliding movement of the link member 9 as maintaining a distance between the seat 3 and the link member 9. When the backrest 2 is inclined to lower position, the link member 9 is pivotally moved about the pivot shaft z4 and is slidably moved toward the front side (footrest-5 side) relative to the rollers 15, thereby pushing up the footrest 5. While the other end of the link member 9 is abutted against the backside portion of the footrest 5, an abutting position thereof is not fixed. In conjunction with an inclining motion of the footrest 5, therefore, the other end of the link member 9 pushes up the footrest 5 as sliding on the backside portion of the footrest 5 (sliding movement).

A more detailed description is made on the footrest 5. The footrest 5 is pivotally mounted to a front portion of the seat 3 and is inclined relative to the seat 3 or the chair installation surface (horizontal plane) by means of the footrest angle interlocking mechanism f.

The footrest 5 further includes a first expanding/contracting mechanism for moving the footrest 5 toward or away from the seat 3. As shown in FIG. 7, a first segment 5a of the footrest 5 is pivotally connected to the seat 3 by means of a footrest support shaft z5. The first segment 5a and the footrest support shaft z5 are interconnected by means of a first slide member 5d slidably movable relative to the first segment 5a. The first segment 5a is slidably moved on the first slide member 5d, thereby varying a distance between the seat 3 and the footrest 5. FIG. 7 shows a state where the footrest 5 is moved away from the seat 3 by means of the first expanding/contracting mechanism.

The footrest 5 has an articulated structure which includes: the first segment 5a principally serving to massage the calves of the massagee h; and a second segment 5b principally serving to massage the heels, dorsa and soles of the feet of the massagee h. The footrest 5 further includes a second expanding/contracting mechanism for moving the second segment 5b toward or away from the first segment 5a. As shown in FIG. 7, the first segment 5a and the second segment 5b are interconnected by means of a second slide member 5e. The second slide member 5e is fixed to either one of the first segment 5a or the second segment 5b and is adapted for sliding movement relative to the other. A distance between the first segment 5a and the second segment 5b is varied by means of such a second slide member 5e. FIG. 7 shows a state where the first segment 5a and the second segment 5b are spaced away from each other by means of the second expanding/contracting mechanism.

The aforementioned first expanding/contracting mechanism and second expanding/contracting mechanism provide for the adjustment of positions of the first segment 5a and the second segment 5b according to the length of the leg of the massagee hand the seated position of the massagee.

Each of the first expanding/contracting mechanism and the second expanding/contracting mechanism includes an unillustrated elastic member (such as a spring) which urges the mechanism in a direction to reduce the expandable length thereof. Specifically, the first slide member 5d and the second slide member 5e are each provided with the elastic member such as a spring. The elastic member of the first slide member 5d urges the first slide member 5d in a direction to reduce the distance between the first segment 5a and the seat 3 (direction to contract the first slide member 5d). The elastic member of the second slide member 5e urges the second slide member 5b to reduce the distance between the first segment 5a and the second segment 5b (direction to contract the second slide member 5e). The slide members 5d, 5e may be expanded by applying thereto forces exceeding the urging forces of these elastic members in expanding directions. In a case where an elastic modulus (such as spring constant) of the elastic member of the first slide member 5d is greater than an elastic modulus (such as spring constant) of the elastic member of the second slide member 5e, the second slide member 5e may be slidably moved by a greater quantity than that of the sliding movement of the first slide member 5d. This is because the second slide member 5e having the smaller elastic modulus is expanded in preference to the first slide member 5d having the greater elastic modulus. Conversely, in a case where the elastic modulus (such as spring constant) of the elastic member of the first slide member 5d is smaller than the elastic modulus (such as spring constant) of the elastic member of the second slide member 5e, the first slide member 5d may be slidably moved by a greater quantity than that of the sliding movement of the second slide member 5e. This is because the first slide member 5d having the smaller elastic modulus is expanded in preference to the second slide member 5e having the greater elastic modulus. That is, if the elastic members (such as springs) are provided at both of the first expanding/contracting mechanism and the second expanding/contracting mechanism, the locations of the first segment 5a and the second segment 5b (the location of the footrest 5 relative to the seat 3, and the distance between the first segment 5a and the second segment 5b) may be varied by adjusting the strength (elastic modulus) of each of the elastic members (spring).

As shown in FIG. 1, the first segment 5a of the footrest 5 includes first lateral-side walls 5a1 which upstand from the lateral sides thereof and oppose each other. These first lateral-side walls 5a1 are each provided with an outer air cell 51 at a lateral inside surface thereof, the outer air cells serving to press the calves on the outer sides thereof. On the other hand, center air cells 52 are provided at transversely intermediate places between the two first lateral-side walls 5a1, the center air cells serving to press the calves on the inner sides thereof. These center air cells 52 are disposed on either side with respect to a transversely central line of the footrest 5. When the massagee h receives a massage, the massagee places the individual legs (the calves) in individual spaces defined between the outer air cell 51 and the center air cell 52. When supplied with air, the outer air cell 51 is inflated transversely inwardly, and the center air cell 52 is inflated transversely inwardly. Thus, the first segment 5a is able to massage the calves of the massagee h as clamping the calves by means of the outer air cells 51 and the center air cells 52.

Next, description is made on the second segment 5b of the footrest 5.

According to the invention, individual directions with respect to the footrest 5 and the second segment 5b are defined as follows. In a standard feet-resting position wherein the massagee h is seated with the legs placed in the footrest 5 in normal position to form an angle of substantially 90° at the ankle, as shown in FIG. 2, a direction substantially along a longitudinal direction of a sole h1 of the massagee h is defined as a sole-longitudinal direction U, whereas a direction substantially along a normal direction to the sole surface (longitudinal direction of a calf h2 of the massagee h) is defined as a sole-normal direction H. The sole-longitudinal direction U and the sole-normal direction H are substantially perpendicular to each other.

With respect to the sole-longitudinal direction U, a direction directed from a heel h3 toward a toe h4 of the massagee h in the aforesaid feet-resting position is defined as a sole-longitudinally forward direction U1, whereas a direction directed from the toe h4 toward the heel h3 is defined as a sole-longitudinally rearward direction U2 (see FIG. 2).

With respect to the sole-normal direction H, a direction directed from the sole h1 toward a knee h5 of the massagee h in the aforesaid feet-resting position is defined as a sole-normally upward direction H1, whereas a direction directed from the knee h5 toward the sole h1 is defined as a sole-normally downward direction H2 (see FIG. 2).

Therefore, a transverse direction sy of the chair-type massaging machine 1 is perpendicular to the sole-longitudinal direction U and is also perpendicular to the sole-normal direction H. As shown in FIG. 7, the relations between the sole-longitudinal direction U and the vertical direction and between the sole-normal direction H and the vertical direction are varied with the inclination of the footrest 5. The footrest 5 is capable of pivotally moving from a position where the sole-normal direction H thereof is substantially aligned with the vertical direction (shown in FIG. 1 and FIG. 2) to a position where the sole-normal direction H thereof is close to the horizontal direction.

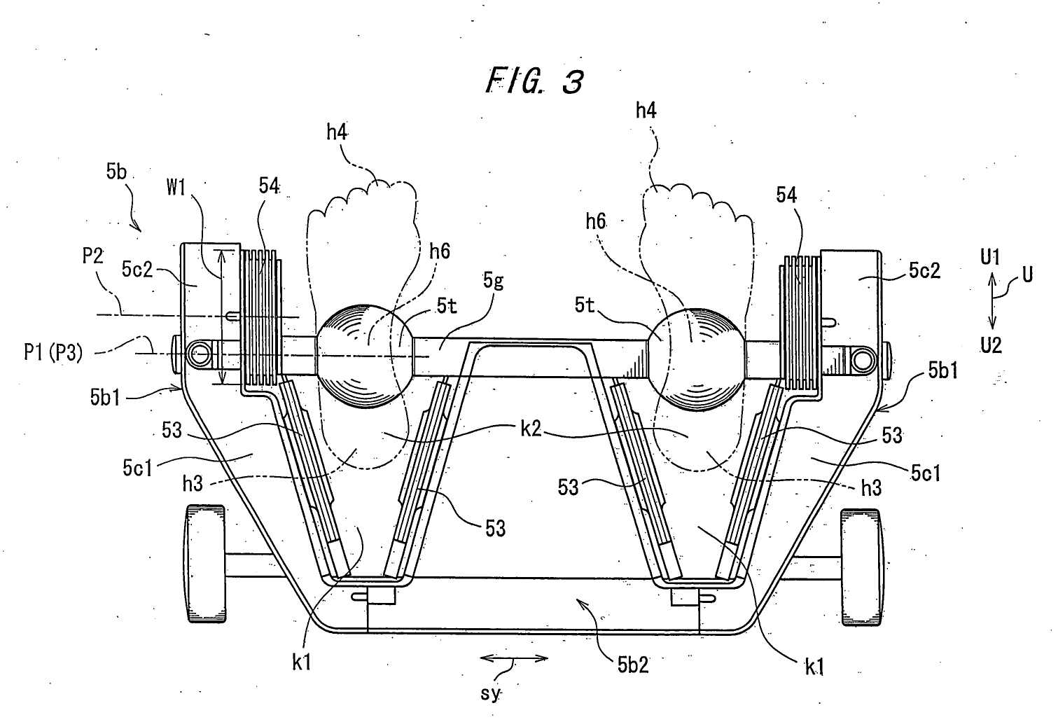

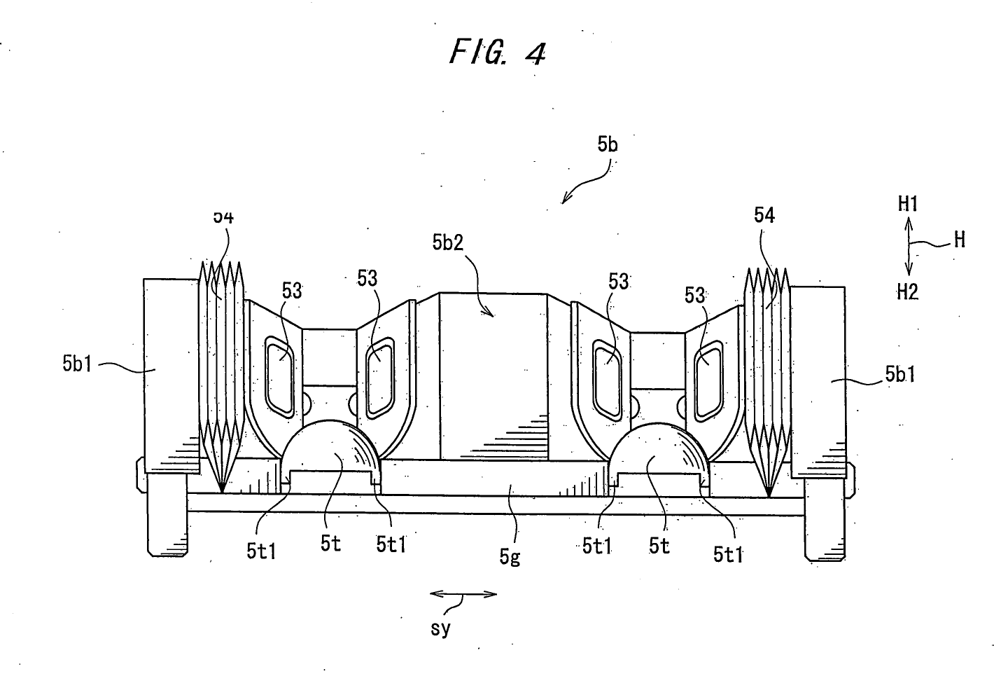

FIG. 3 is a diagram of a single body of the second segment 5b as viewed from above along the sole-normal direction. FIG. 4 is a diagram of the single body of the second segment 5b as viewed from front along the sole-longitudinal direction. As shown in FIG. 1, FIG. 3 and FIG. 4, the second segment 5b includes: a pair of second lateral-side walls 5b1 upstanding from lateral sides of the footrest and opposing each other; and a second center wall 5b2 upstanding from place transversely intermediate between these second lateral-side walls 5b1.

As shown in FIG. 3, the second lateral-side wall 5b1 includes: a rear wall portion 5c1 opposing the second center wall 5b2; and a front wall portion 5c2 extended sole-longitudinally forwardly from the rear wall portion 5c1 and projected sole-longitudinally forwardly relative to the second center wall 5b2. While the rear wall portion 5c1 and the second center wall 5b2 (a lateral side thereof) transversely oppose each other, a transverse distance therebetween is progressively decreased toward a sole-longitudinally rear side. A heel-massaging air cell 53, as a heel massaging portion, is provided at each of the opposing surfaces of the rear wall portion 5c1 and the second center wall 5b2. The heel-massaging air cells 53 are adapted to press not only the heel h3 but also the Achilles tendon of the massagee h as clamping the heel and tendon on the lateral sides thereof.

As shown in FIG. 4 and FIG. 3, a plantar-arch projection 5t is provided at place corresponding to a sole-normally lower end of the heel-massaging air cell 53 and to a sole-longitudinally front end of the heel-massaging air cell 53. The plantar-arch projections 5t are disposed at places substantially corresponding to the locations of plantar arches h6 of the massagee h in the aforementioned standard feet-resting position. The lateral plantar-arch projections 5t transversely arranged are each configured to project upwardly in the sole-normal direction (see FIG. 4) and hence, are capable of stimulating not only the plantar arches h6 but also the soles h1 of the massagee h. The plantar-arch projections 5t are supported by a bar-like member 5g transversely interconnecting the lateral-side walls 5b1 opposing each other. A width of the bar-like member 5g with respect to the sole-longitudinal direction is smaller than that of the plantar-arch projection 5t. In the second segment 5b, what is present sole-normally downwardly from the soles of the massagee in the above feet-resting position are the plantar-arch projections 5t and the bar-like member 5g. In the second segment 5b, therefore, an area around the plantar-arch projections 5t and on the heel-location side with respect to the feet-resting position is open downward in the sole-normal direction. Furthermore, an area around the plantar-arch projections 5t and on the toe-location side with respect to the feet-resting position is open downward in the sole-normal direction.

A material of the plantar-arch projection 5t is not particularly limited. Usable materials include resins, rubber, metals and the like.

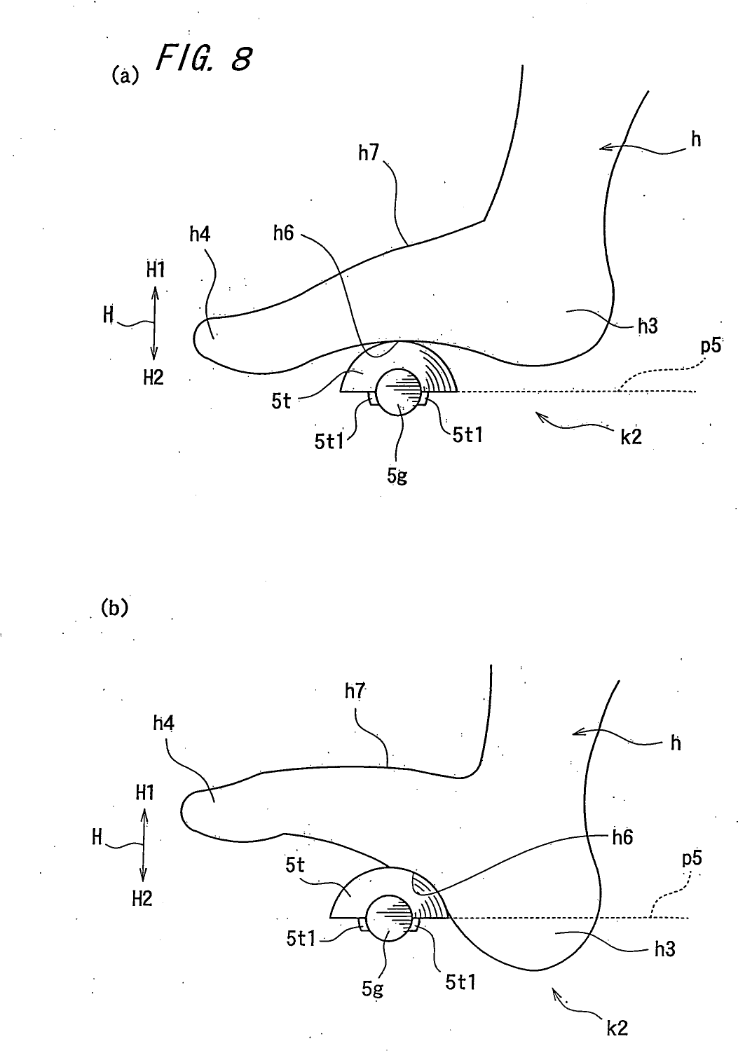

As a result of providing the area opened downward in the sole-normal direction, there is defined a second space k2 which is located around the plantar-arch projection 5t and on the heel-location side with respect to the feet-resting position and which extends sole-normally downwardly from the plantar-arch projection 5t (a sole-normally lower end thereof p5: indicated by a broken line in FIG. 8) (see FIG. 3 and FIG. 8). In this case, as shown in FIG. 8(b), the massagee h is allowed to insert the heel h3 into the second space k2 by varying the angle of ankle (reducing the angle from 90°) or such. In other words, the massagee is allowed to place the heel h3 sole-longitudinally downwardly from the sole-normally lower end position p5 of the plantar-arch projection 5t (see FIG. 8(b)). This leads to an increased freedom of abutting angle and position of the sole relative to the plantar-arch projection 5t. Thus, the plantar-arch projection 5t may provide an even higher massage effect on the sole. In the second segment 5b, the second space k2 is not merely provided but the area on the heel-location side with respect to the feet-resting position is open downward in the sole-normal direction. Hence, the area not only provides the aforesaid second space k2 but also prevents the soles from getting sweaty or prevents dirt and dust separated from the soles from being accumulated in the neighborhood of the plantar-arch projections 5t. Thus are ensured quite comfortable conditions for sole massage.

Because of the provision of the open space, the footrest 5 may be reduced in weight as compared with a case where no open space is provided (such as where the sole support surface of the prior-art document is provided). Therefore, load on a driving device for inclining the footrest 5 (the actuator 6) may be reduced, so that the driving device may be reduced in size and weight.

The footrest 5 (the second segment 5b thereof) is not provided with the sole support surface to support substantially the overall area of the soles of the feet (e.g., the sole support surface of the aforementioned prior-art document). In a case where the sole support surface is provided, the sole h1 is brought to a high position when the footrest 5 is erected as shown in FIG. 2. This raises need for accordingly increasing the height of the whole body of the chair-type massaging machine 1 including the seat surface 3a. However, the chair-type massaging machine 1 need not provide a margin for the thickness of the sole supporting surface and hence, may be reduced in height as a whole. Thus, the machine can achieve the size reduction.

Incidentally, the footrest 5 (the second segment 5b thereof) may be provided with a surface confronting the soles.

In a case where the footrest 5 (the second segment 5b thereof) is provided with the surface confronting the soles, the sole confronting surface may preferably be provided in a manner to define the aforesaid space k2. In other words, it is preferred to provide the sole confronting surface at the footrest 5 in a manner not to interfere with the insertion of the heels.

In the feet-resting position where the plantar arches h6 of the massagee h rest on the plantar-arch projections 5t, as shown in FIG. 3, heel-massaging air cells 53 are located at positions to clamp and press the heels h3. A first space k1 is provided at place sole-longitudinally rearwardly of the heels h3 in the above feet-resting position. With respect to the feet-resting position, the first space k1 capable of receiving the heels h3 is provided sole-longitudinally rearwardly of the heels h3. This allows the massagee to adjust sole-longitudinal positions of the soles by inserting the heels h3 in the first space k1, and also to place the plantar arches h6 exactly on the plantar-arch projections 5t. This also increases the degree of freedom of selecting the positions of massage applied by the heel-massaging air cells 53. If a space such as the first space k1 is not provided and hence, the positioning of the soles (positioning with respect to the sole-longitudinal direction) is accomplished by surface-contacting the heels h3 against an abutment surface disposed sole-longitudinally rearwardly of the heels h3, the sole-longitudinal positions of the soles are limited by the position of the heel-abutment surface, so that the plantar arches h6 of the massagee may sometimes be deviated from the plantar-arch projections 5t. In this case, the massagee cannot shift the soles rearward in the sole-longitudinal direction. Therefore, the massagee may be unable to press a desired part of each sole against the plantar-arch projection 5t or the heels h3 may be displaced from the positions of massage applied by the heel-massaging air cells 53. However, the aforementioned arrangement provides an increased degree of freedom of positioning the soles with respect to the sole-longitudinal direction and besides, permits the adjustment of the sole-longitudinal positions of the soles on the basis of the positions of the plantar arches h6. Accordingly, the massagee can place the plantar arches h6 exactly on the plantar-arch projections 5t. Furthermore, the effect of massage applied by the plantar-arch projections 5t and lateral-side air cells 54 is enhanced.

As shown in FIG. 3, the heel h3 of human body is configured to be progressively decreased in width toward its end. In addition, the heel-massaging air cells 53 in opposing relation are laid in a manner that a distance therebetween is progressively decreased toward the sole-longitudinally rearward side in order to conform to the configuration of the heel h3. Therefore, the pressing force of the heel-massaging air cells 53 for clamping and pressing the heel is directed toward the toe side as inclined relative to the sole-longitudinal direction, thus producing a component force toward the toe. Hence, the heel-massaging air cells 53 clamping the heel h3 tend to move the heel (or the overall sole) in a manner to push the heel out of the massaging portions. However, the second segment 5b of the aforementioned arrangement permits the heel h3 to be massaged while the concaved plantar arch is pressed against the projected C portion of the plantar-arch projection 5t. Thus, the physical locking effect of the plantar-arch projection 5t prevents the soles from being displaced (moved) toward the toe (sole-longitudinally forwardly) when the heels h3 are clamped and pressed. Accordingly, the heels h3 and the plantar arches h6 may be effectively massaged.

If the soles are less prone to move sole-longitudinally forwardly, the massage effect on the calves by means of the first segment 5a is also increased. When the soles are displaced sole-longitudinally forwardly, the calves are also displaced in the same direction. Thus, the calves h2 are displaced from the place between the outer air cells 51 and the center air cells 52. In this case, therefore, the massage effect on the calves by means of the air cells 51, 52 is decreased. As described above, however, the soles are less prone to move sole-longitudinally forwardly and hence, the massage effect on the calves h2 is also enhanced.

Although not shown in FIG. 1 and the like, a cover member such as formed of cloth or leather is used for covering the air cells provided at the footrest 5, the air cells including the outer air cells 51, the center air cells 52, the heel-massaging air cells 53 and the lateral-side air cells 54. However, the plantar-arch projections 5t are not covered with the cover member but are exposed. Hence, the plantar-arch projections 5t directly contact the plantar arches h6 of the massagee h. In this case, the plantar-arch projections 5t are prevented from being flattened due to the cover member and the like covering the plantar-arch projections. Therefore, the physical locking effect of the plantar-arch projections 5t is enhanced even further, so that a more effective massage may be applied to the plantar arches h6 and the heels h3.

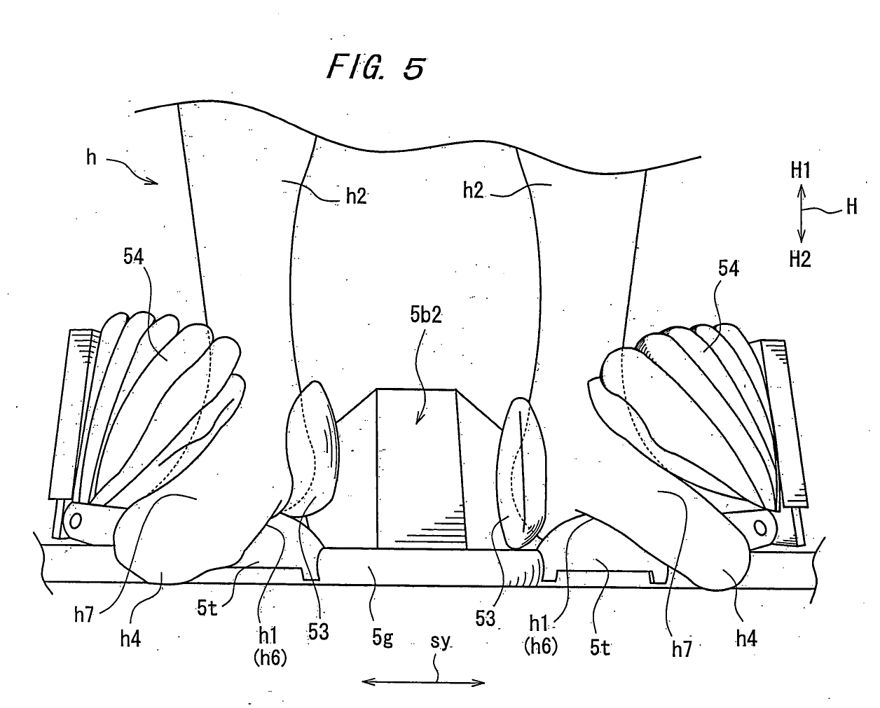

The second segment 5b is provided with other air cells besides the heel-massaging air cells 53. Specifically, the lateral-side air cells 54 principally serving to press “the dorsa of the feet” h7 of the massagee h are disposed at each of the opposing surfaces of the front wall portion 5c2 on the lateral sides. The lateral-side air cell 54 has a bellow-like structure wherein a plurality of air cells overlapped with one another are communicated with one another. As shown in FIG. 5, the lateral-side air cell 54 is designed to inflate in a fan shape on a fulcrum defined by a lower side thereof with respect to the sole-normal direction. Thus, the lateral-side air cells 54 are capable of pressing “the dorsa of the feet” h7 in the feet-resting position where the plantar arches h6 rest on the plantar-arch projections 5t.

As shown in FIG. 3, a sole-longitudinal center position P1 of the plantar-arch projection 5t is included in a sole-longitudinal mounting range W1 of the lateral-side air cell 54. Hence, the plantar-arch projections 5t in cooperation with the lateral-side air cells 54 can efficiently clamp and massage the feet of the massagee h. In other words, the feet of the massagee h may be efficiently pressed against the plantar-arch projections 5t by means of the lateral-side air cells 54. Thus is further enhanced the massage effect (pressing effect) of the plantar-arch projections 5t.

As shown in FIG. 3, a sole-longitudinal center position P2 of the lateral-side air cell 54 is located sole-longitudinally forwardly of the sole-longitudinal center position P1 of the plantar-arch projection 5t. Furthermore, the sole-longitudinal center position P2 of the lateral-side air cell 54 is located sole-longitudinally forwardly of the uppermost position P3 or the highest projection point of the plantar-arch projection 5t with respect to the sole-normal direction. When the lateral-side air cell 54 is inflated, therefore, a toe-side portion of “the dorsum of the foot” h7 is pressingly bent downward in the sole-normal direction by the pressing force of the lateral-side air cell 54 in combination with the resultant resistance from the plantar-arch projection 5t. Accordingly, the aforesaid physical locking effect of the plantar-arch projection 5t is even further enhanced, while the effect of acupressure applied by the plantar-arch projection 5t is also increased. Thus, the footrest 5 may provide quite an effective massage.

The plantar-arch projection 5t is adapted to be removably mounted to the bar-like member 5g. Specifically, the plantar-arch projection 5t is mounted to the bar-like member 5g by way of a locking projection 5t1 which is elastically deformed so as to be fitted on a periphery of the bar-like member 5g having a circular section. This facilitates the replacement of the plantar-arch projection 5t, so that the massagee h may select any favorite one from a variety of plantar-arch projections 5t of different specifications including size, configuration, hardness and the like. The bar-like member 5g and/or the plantar-arch projection 5t may preferably be provided with a locking mechanism (concave/convex, step or the like) for inhibiting the plantar-arch projection 5t from being displaced in a longitudinal direction of the bar-like member 5g. The bar-like member 5g and/or the plantar-arch projection 5t may further preferably be provided with a locking mechanism (concave/convex, step or the like) for inhibiting the plantar-arch projection 5t from being rotated relative to a circumferential direction of the bar-like member 5g. These locking mechanisms ensure that the plantar-arch projection 5t is positively fixed to place and hence, the effect of massage applied by the plantar-arch projection 5t is enhanced.

Furthermore, the bar-like member 5g and/or the plantar-arch projection 5t may be provided with an adjustment mechanism for adjusting the fixing position of the plantar-arch projection 5t with respect to a transverse direction of the bar-like member. The bar-like member 5g and/or the plantar-arch projection 5t may also be provided with an adjustment mechanism for adjusting a circumferential position of the plantar-arch projection with respect to the bar-like member 5g. These adjustment mechanisms permit the massagee h to vary the location of the plantar-arch projection 5t as the massagee likes it. Therefore, the effect of massage applied by the plantar-arch projection 5t may be enhanced even further.

What is claimed is:

1. A chair-type massaging machine comprising:
a seat surface for a massagee to be seated thereon;
a plantar-arch projection for the seated massagee to place plantar arches thereon; and
a heel massaging portion capable of clamping and pressing heels in a feet-resting position where the plantar arches rest on the plantar-arch projection.

2. A chair-type massaging machine according to claim 1, wherein a space extending sole-normally downwardly of the plantar-arch projection is provided at an area around the plantar-arch projection and on a heel-location side with respect to the feet-resting position.

3. A chair-type-massaging machine according to claim 1, wherein a space defined around the plantar-arch projection and on a heel-location side with respect to the feet-resting position is open downward in the sole-normal direction.

4. A chair-type massaging machine according to claim 1, wherein a space capable of receiving the heels is provided at place sole-longitudinally rearwardly of the heel location with respect to the feet-resting position.

5. A chair-type massaging machine according to claim 1, wherein the plantar-arch projection is exposed for directly contacting the plantar arches of the massagee.
